(19) United States
(12) Patent Application Publication
(10) Pub. No.: US 2011/0155869 A1
(43) Pub. Date: Jun. 30, 2011

(54) Adjustable support device for monitor

(75) Inventor: Hsin Hao Chen, Taipei Hsien (TW)

(73) Assignee: Kernan Technology Co., Ltd.

(21) Appl. No.: 12/655,453

(22) Filed: Dec. 30, 2009

(51) Int. Cl. F16M 11/04; F16M 11/10

(52) U.S. Cl. 248/125.8

(57) ABSTRACT

An adjustable support device includes a supporting member having two spaced arms each of which includes a sliding engaging member, a carrier for an article or monitor includes two sliding engaging elements slidably engaged with the sliding engaging members of the arms for allowing the carrier to be moved relative to the supporting member to selected positions, and a number of rolling members are attached to the arms and engaged with the sliding engaging elements of the carrier for allowing the carrier to be smoothly moved relative to the supporting member to the selected positions with a suitably reduced or decreased friction between the carrier and the supporting stand, a spring member resiliently couples the carrier to the supporting member.

### BACKGROUND OF THE INVENTION

1. Field of the Invention

The present invention relates to an adjustable support device, and more particularly to an adjustable support device including a smooth sliding structure or mechanism for smoothly coupling or attaching or mounting a monitor carrier to a supporting stand and for reducing or decreasing a friction between the carrier and the supporting stand.

2. Description of the Prior Art

Various kinds of typical adjustable support devices have been developed and comprise a support member or carrier member attached or mounted to a supporting stand and for supporting various objects, such as monitors, displays, screens, keyboards, antenna members, or the like.

For example, U.S. Pat. No. 4,834,329 to Delapp, U.S. Pat. No. 5,037,054 to McConnell, U.S. Pat. No. 5,123,621 to Gates, U.S. Pat. No. 5,553,820 to Karten et al., U.S. Pat. No. 5,713,549 to Shieh, U.S. Pat. No. 6,863,252 to Bosson, and U.S. Pat. No. 7,413,152 to Chen disclose several of the typical support devices or carrier devices each also comprising a support member or carrier member pivotally or rotatably attached or mounted or coupled to a supporting stand with one or more pivotal arms for supporting various objects, such as monitors, displays, keyboards, antenna members, or the like.

However, normally, the support members or carrier members and the pivotal arms and the supporting stands are pivotally or rotatably coupled together with pivot joints or axles and are adjustable to different angular positions by a frictional force between the members or elements, such that the coupling portions between the members or elements will be easily worn out or damaged after use.

The present invention has arisen to mitigate and/or obviate the afore-described disadvantages of the conventional adjustable support devices.

### SUMMARY OF THE INVENTION

The primary objective of the present invention is to provide an adjustable support device including a smooth sliding structure or mechanism for smoothly coupling or attaching a monitor carrier to a supporting stand and for reducing or decreasing a friction between the carrier and the supporting stand.

In accordance with one aspect of the invention, there is provided an adjustable support device comprising a supporting member including two arms extended therefrom and spaced from each other, and each having a sliding engaging member provided therein, a carrier for supporting an article including two sliding engaging elements slidably engaged with the sliding engaging members of the arms respectively for allowing the carrier to be moved relative to the supporting member to selected positions, and a number of rolling members attached to the arms and engaged with the sliding engaging elements of the carrier for allowing the carrier to be smoothly moved relative to the supporting member to the selected positions with a suitably reduced or decreased friction between the carrier and the supporting stand and for smoothly adjusting the carrier relative to the supporting member.

The sliding engaging elements of the carrier are side portions of the carrier each including a rolling raceway formed therein for engaging with the rolling members.

The sliding engaging members of the arms are channels formed in the arms respectively for slidably engaging with the side portions of the carrier respectively.

The channels of the arms are preferably the curved channels, and the side portions of the carrier are preferably the curved side portions for slidably engaging with the curved channels of the arms respectively.

The carrier includes a spring member attached to the carrier and resiliently coupled between the carrier and the supporting member.

The spring member includes a first end attached to the supporting member for resiliently coupling the carrier to the supporting member.

The spring member includes a curved mechanism provided in the free end thereof for maintaining the carrier to the supporting member at the selected positions.

The carrier includes a casing attached to either of the sliding engaging elements of the carrier for supporting the spring member. The spring member is preferably a coil spring member. The carrier includes at least one bar coupled between the sliding engaging elements of the carrier.

A stationary base may further be provided and engaged with the supporting member for supporting the supporting member. The stationary base includes a socket opening formed therein for receiving a lower portion of the supporting member. The supporting member is pivotally attached to the stationary base with a pivot shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a rear perspective view of an adjustable support device in accordance with the present invention;

FIG. 2 is a front perspective view of the adjustable support device;

FIG. 3 is a partial exploded view of the adjustable support device;

FIG. 4 is a cross sectional view of the adjustable support device taken along lines 4-4 of FIG. 2;

FIG. 5 is a cross sectional view similar to FIG. 4, illustrating the operation of the adjustable support device;

FIGS. 6, 7 are partial side plan schematic views illustrating the operation of the adjustable support device; and

FIG. 8 is a side plan schematic view illustrating the operation of the adjustable support device.

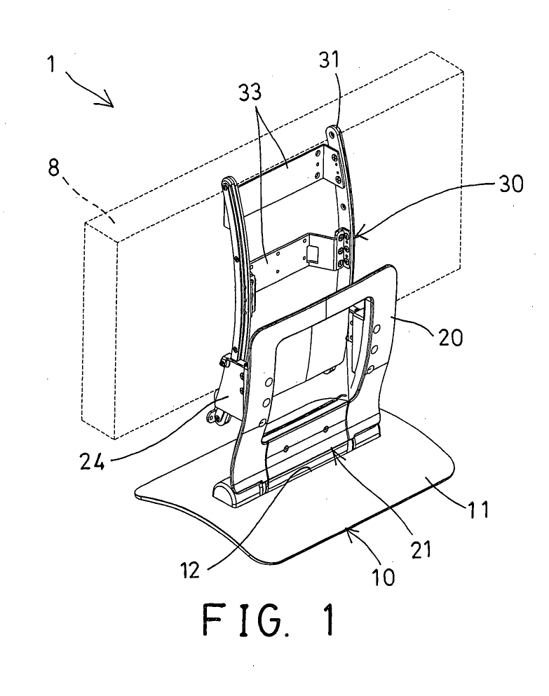

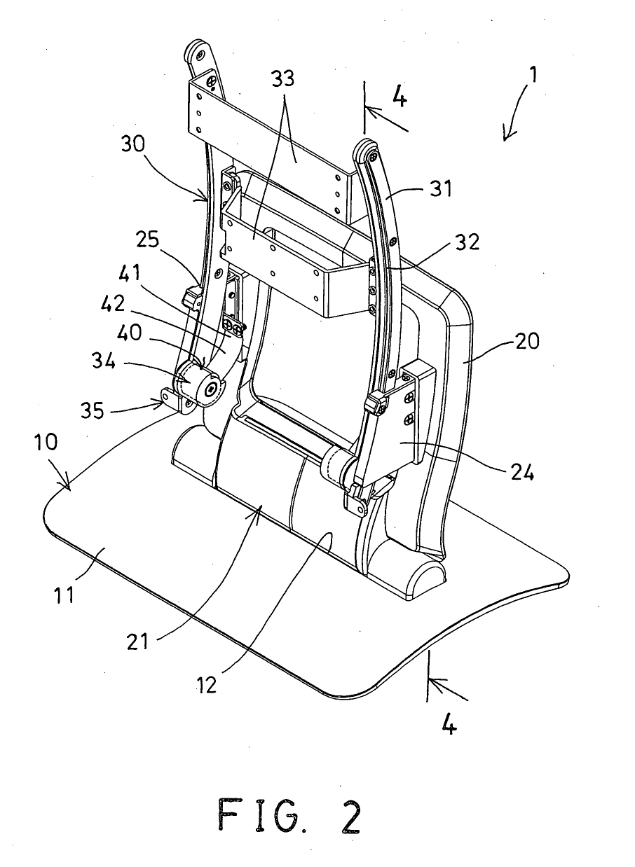

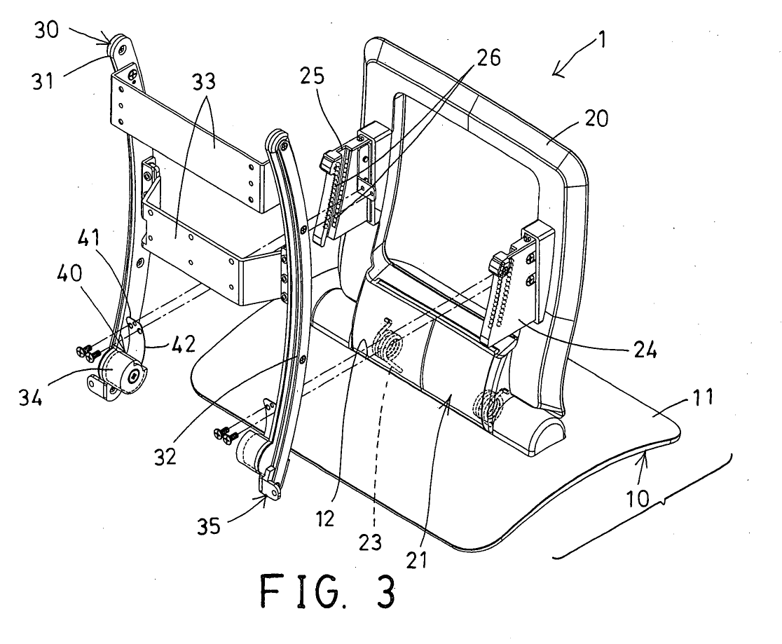

### DETAILED DESCRIPTION OF THE PREFERRED EMBODIMENT

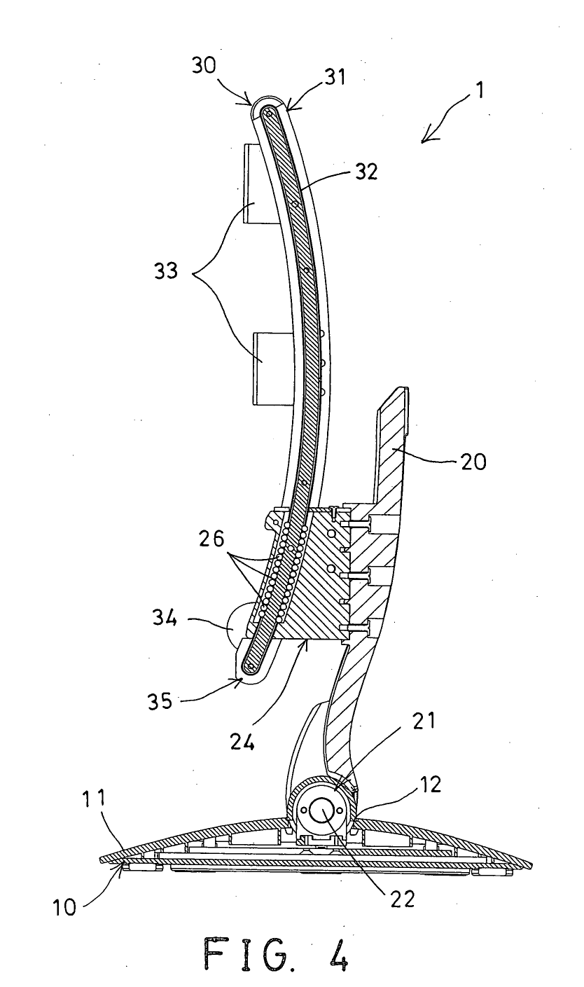

Referring to the drawings, and initially to FIG. an adjustable support device 1 in accordance with the present invention comprises a supporting stand 10 including a stationary base 11 having a curved structure, such as an upwardly curved structure and having a socket opening 12 formed therein, and including a supporting bracket or member 20 having a lower portion 21 engaged into the socket opening 12 of the stationary base 11 and pivotally or rotatably attached or mounted or coupled to the stationary base 11 with a pivot shaft 22 (FIGS. 4-8) for allowing the supporting member 20 to be pivoted or rotated relative to the stationary base 11 to selected angular positions.

One or more spring biasing members 23 may further be provided and attached or mounted onto the pivot shaft 22, and engaged with or engaged between the stationary base 11 and the supporting member 20 for resiliently supporting the supporting member 20 at the selected or suitable angular positions relative to the stationary base 11. A latch or lock mechanism (not shown) may further be provided and attached or mounted or engaged between the stationary base 11 and the supporting member 20 for stably or solidly securing or positioning the supporting member 20 to the stationary base 11 at the selected or suitable angular positions relative to the stationary base 11. The above-described latch or lock mechanism is not related to the present invention and will not be described in further details.

The supporting member 20 includes one or more (such as two) protrusions or arms 24 extended forwardly therefrom and spaced from each other and preferably parallel to each other, and each having a sliding engaging member 25, such as a rail or track or channel 25, and particularly a curved channel 25 formed or provided therein, in which the sliding engaging members or channels 25 of the arms 24 are directed or facing toward each other and also preferably parallel to each other, and the supporting member 20 further includes a number of rollers or ball bearing or rolling members 26 attached or mounted into the arms 24 and partially extended into either or both sides of the sliding engaging members or channels 25 of the arms 24 respectively.

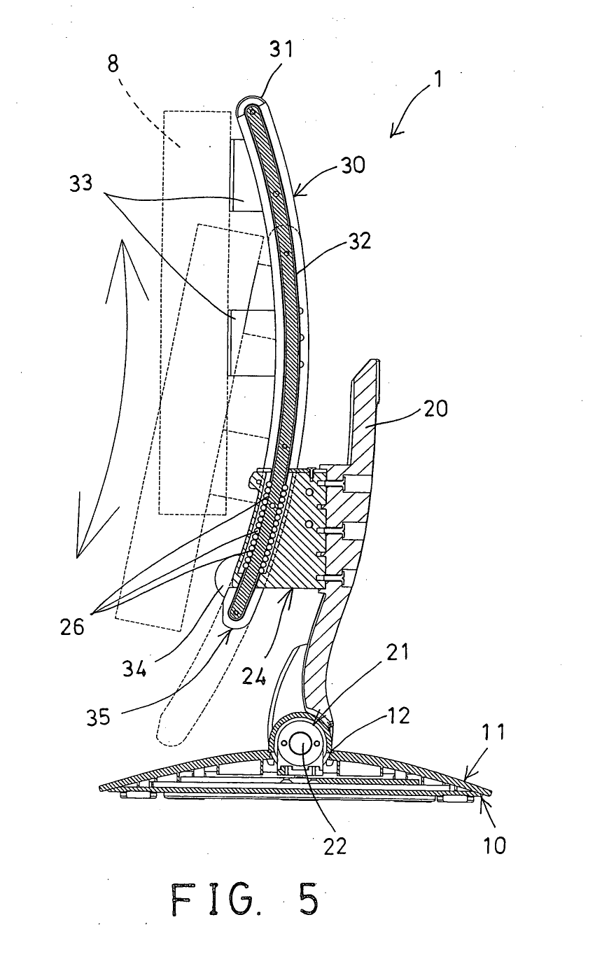

The adjustable support device 1 further includes a carrier 30 having two side edges or portions or rails or tracks or sliding engaging elements 31 slidably engaged into the sliding engaging members or channels 25 of the arms 24 respectively and engaged with the bearing or rolling members 26 for allowing the carrier 30 to be suitably and smoothly moved or slid up and down relative to the supporting member 20 to selected or suitable positions or locations (FIG. 5). The side edges or portions or rails or tracks or sliding engaging elements 31 of the carrier 30 are also preferably curved for suitably engaging with the curved sliding engaging members or channels 25 of the arms 24 respectively for allowing the carrier 30 to be directed or pivoted or rotated relative to the supporting member 20 to selected or suitable angular positions. The carrier 30 may be made or manufactured or formed by metal, steel, plastic or other materials.

It is preferable that the carrier 30 includes an endless ball guiding passage or recess or rolling raceway 32 formed in each of the side edges or portions or rails or tracks or sliding engaging elements 31 of the carrier 30 for suitably engaging with the bearing or rolling members 26 and for smoothly and slidably attaching or mounting the carrier 30 to the supporting member 20, and may further include one or more (such as two) beams or bars 33 attached or mounted or coupled between the side edges or portions or rails or tracks or sliding engaging elements 31 of the carrier 30, and may further include a casing 34 attached or mounted to the lower portion 35 of each of the side edges or portions or rails or tracks or sliding engaging elements 31 of the carrier 30 for suitably engaging with or attaching or mounting or supporting another spring biasing member 40, such as a coil spring member 40 therein and for attaching or mounting the spring member 40 to the carrier 30.

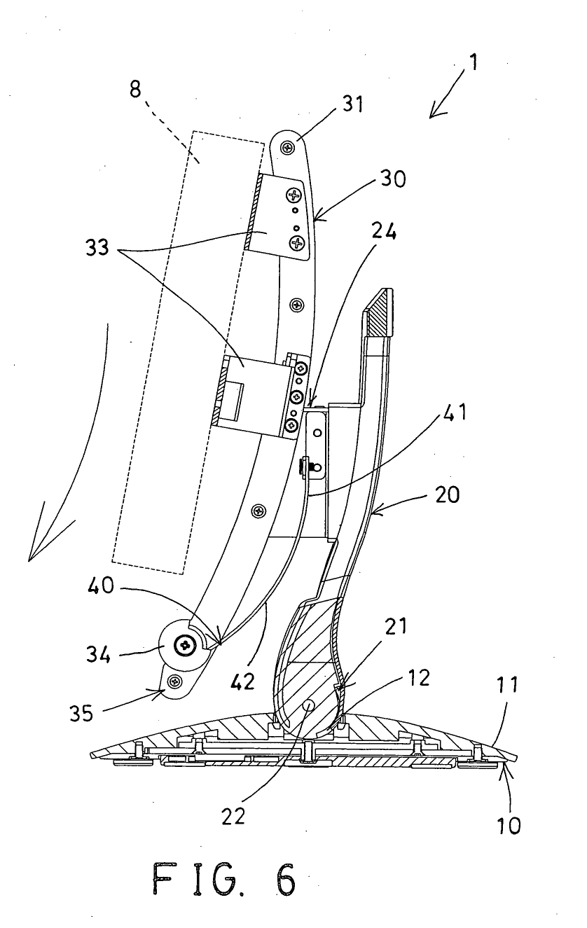

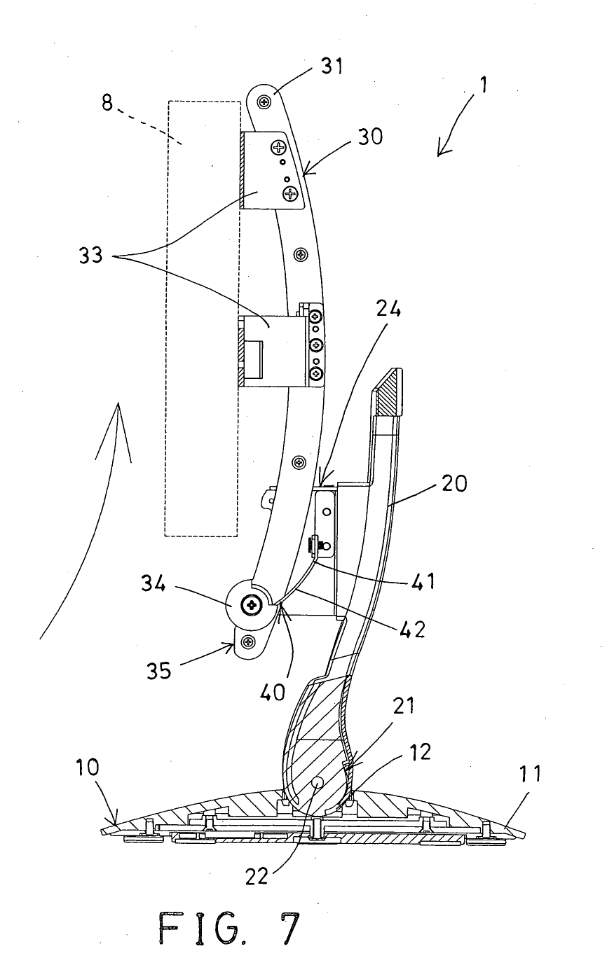

The carrier 30 is shaped and designed for attaching or mounting or supporting an article or object 8, such as a monitor 8, a display, a keyboard, an antenna member, or the like. The spring member 40 includes one end or free end 41 attached or mounted or secured to the supporting member 20 and/or the stationary base 11 for applying a resilient or spring biasing force to the carrier 30 and/or for resiliently coupling the carrier 30 to the supporting member 20, and for resiliently supporting the carrier 30 at the selected or suitable up and down positions or locations and/or at the selected or suitable angular positions relative to the supporting member 20. It is preferable that the spring member 40 includes a curved structure or mechanism 42 formed or provided in the one end or free end 41 thereof for suitably maintaining or retaining the carrier 30 and the article 8 to the supporting member 20 at the selected or suitable up and down positions or locations and/or at the selected or suitable angular positions (FIGS. 6, 7).

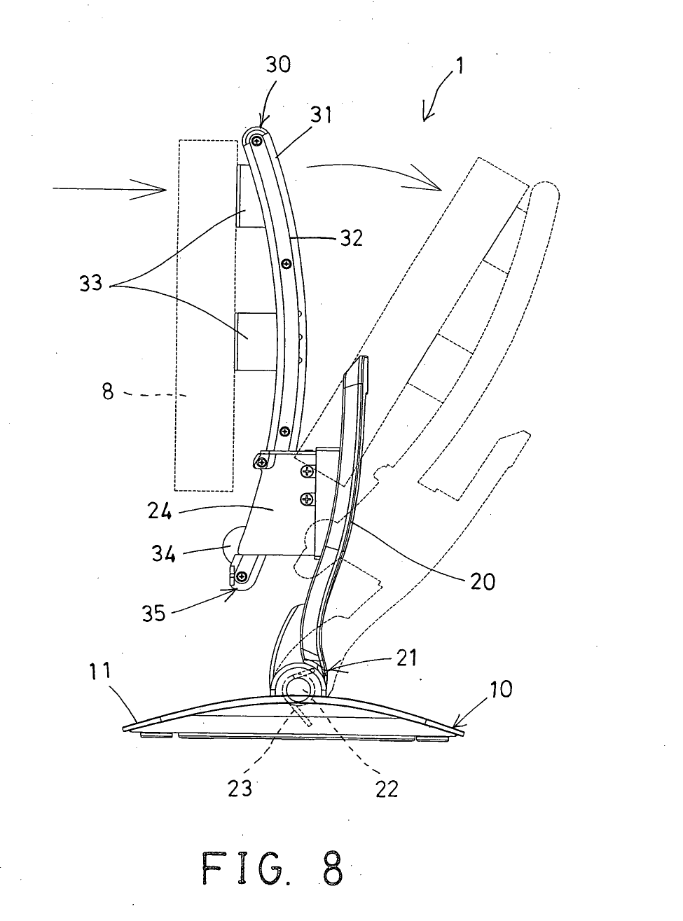

In operation, as shown in FIG. 5, the carrier 30 and the article 8 may be easily and quickly and smoothly moved or slid up and down relative to the supporting member 20 to selected or suitable positions or locations with the sliding engagement between the side edges or portions or rails or tracks or sliding engaging elements 31 of the carrier 30 and the sliding engaging members or channels 25 of the arms 24 respectively and/or with the bearing or rolling members 26, and the spring members 40 may suitably and resiliently support the carrier 30 at the selected or suitable up and down positions or locations and/or at the selected or suitable angular positions relative to the supporting member 20 (FIGS. 6, 7). As shown in FIG. 8, the supporting member 20 and the carrier 30 and the article 8 may be pivoted or rotated relative to the stationary base 11 when contacted or touched or moved by the other objects or persons, and then may be biased back to the original or suitable position with the spring biasing members 23, such that the article 8 may be suitably protected and may be prevented from being stricken or damaged by the other objects or persons inadvertently.

Accordingly, the adjustable support device in accordance with the present invention includes a smooth sliding structure or mechanism for smoothly coupling or attaching a carrier to a supporting stand and for reducing or decreasing a friction between the carrier and the supporting stand.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adjustable support device comprising:
a supporting member including two arms extended therefrom and spaced from each other, and each having a sliding engaging member provided therein,
a carrier for supporting an article including two sliding engaging elements slidably engaged with said sliding engaging members of said arms respectively for allowing said carrier to be moved relative to said supporting member to selected positions, and
a plurality of rolling members attached to said arms and engaged with said sliding engaging elements of said carrier for allowing said carrier to be moved relative to said supporting member to the selected positions.

2. The adjustable support device as claimed in claim 1, wherein said sliding engaging elements of said carrier are side portions of said carrier each including a rolling raceway formed therein for engaging with said rolling members.

3. The adjustable support device as claimed in claim 2, wherein said sliding engaging members of said arms are channels formed in said arms respectively for slidably engaging with said side portions of said carrier respectively.

4. The adjustable support device as claimed in claim 3, wherein said channels of said arms are curved channels, and said side portions of said carrier are curved side portions for slidably engaging with said curved channels of said arms respectively.

5. The adjustable support device as claimed in claim 1, wherein said carrier includes a spring member attached to said carrier and resiliently coupled between said carrier and said supporting member.

6. The adjustable support device as claimed in claim 5, wherein said spring member includes a first end attached to said supporting member for resiliently coupling said carrier to said supporting member.

7. The adjustable support device as claimed in claim 6, wherein said spring member includes a curved mechanism provided in said free end thereof for maintaining said carrier to said supporting member at the selected positions.

8. The adjustable support device as claimed in claim 5, wherein said carrier includes a casing attached to either of said sliding engaging elements of said carrier for supporting said spring member.

9. The adjustable support device as claimed in claim 5, wherein said spring member is a coil spring member.

10. The adjustable support device as claimed in claim 1, wherein said carrier includes at least one bar coupled between said sliding engaging elements of said carrier.

11. The adjustable support device as claimed in claim 1 further comprising a stationary base for supporting said supporting member.

12. The adjustable support device as claimed in claim 11, wherein said stationary base includes a socket opening formed therein for receiving a lower portion of said supporting member.

13. The adjustable support device as claimed in claim 11, wherein said supporting member is pivotally attached to said stationary base with a pivot shaft.
